(19) United States
(12) Patent Application Publication
(10) Pub. No.: US 2008/0208940 A1
(43) Pub. Date: Aug. 28, 2008

(54) RECONFIGURABLE CIRCUIT

(75) Inventor: Hiroshi FURUKAWA, Kawasaki (JP)

Correspondence Address: ARENT FOX LLP, 1050 CONNECTICUT AVENUE, N.W., SUITE 400, WASHINGTON, DC, 20036, US

(73) Assignee: FUJITSU LIMITED, Kawasaki (JP)

(21) Appl. No.: 12/035,069

(22) Filed: Feb. 21, 2008

(30) Foreign Application Priority Data
Feb. 22, 2007 (JP) 2007-42342

(51) Int. Cl. G06F 17/00; G06F 7/44

(52) U.S. Cl. 708/209; 708/620

(57) ABSTRACT

A reconfigurable circuit including a multiplier for multiplying a value, an accumulator for cumulatively adding said multiplied value and a round-off processing unit for rounding off said cumulatively added value; wherein said multiplier, said accumulator and said round-off processing unit are disposed within a single processing element and said accumulator provides an output at a timing according to a control signal.

### CROSS-REFERENCE TO RELATED APPLICATIONS

This application is based upon and claims the benefit of priority from the prior Japanese Patent Application No. 2007-42342 filed on Feb. 22, 2007, the entire contents of which are incorporated herein by reference.

### BACKGROUND OF THE INVENTION

1. Field of the Invention

An aspect of the present invention relates to a reconfigurable circuit.

2. Description of Related Art

FIG. 1 is a block diagram illustrating a configuration example of a processing element (PE) 1100. A reconfigurable circuit is comprised of a multitude of processing elements. The processing element 1100 has registers (flip-flops) 1101, a selector 1102, a multiplier 1103 and an arithmetic logical unit (ALU) 1104. The registers 1101 retain values. The selector 1102 selects one of two input values and outputs the value. The multiplier 1103 performs multiplications. The ALU 1104 performs, for example, additions.

Japanese Laid-Open Patent Application No. 2005-515525 describes a cell element field for data processing having function cells which perform arithmetic and/or logical functions and memory cells which receive information and store and/or output the information. In the cell element field, control connections are led from the function cells to the memory cells.

In addition, Japanese Laid-Open Patent No. 9-62656 describes a parallel computer having a plurality of PEs, a controller, a first communication route for connecting between the PEs and the controller, and a second communication route for connecting adjacent PEs, in addition to the first communication route. The controller has means for distributing the column and row vectors of a first matrix (first vector) and the column and row vectors of a second matrix (second vector) to the PEs. In addition, each PE has a first memory, a second memory, a multiplier for multiplying the first vector stored in the first memory by the second vector stored in the second memory on an element-by-element basis, an adder for cumulatively adding the result of multiplication, and a control means for storing the transferred first vector in the first memory, storing the transferred second vector in the second memory, transferring the result of cumulative addition to the controller, and transferring the second vector to the adjacent PEs using the second communication route.

Furthermore, Japanese Laid-Open Patent No. 2005-165435 describes a data transmission method that uses a transfer path in which register groups each including a plurality of registers respectively corresponding to a plurality of processing elements are previously connected in series. The data transmission method includes a transfer step of sequentially and continuously transferring data in a plurality of data areas and an input/output step of reading data from and/or writing data to a data area if the data area, whose data has been transferred to one resister of the register groups, is available to a processing unit corresponding to the register.

In the case of the processing element 1100 described above, it is necessary to repeat the process of outputting computation results to the outside of the processing element 1100 and inputting the computation results to another processing element via a network when performing cumulative addition or round-off processing. Another processing element performs cumulative addition or round-off processing. In this case, resources including computing units and data networks are consumed in extremely large quantities. In addition, when realizing complex functions with a plurality of processing elements, there arises the need for, for example, overall control and timing adjustment.

If the reconfigurable circuit employs a 16-bit or 32-bit architecture, then the bus width of data also has the same bit length. Thus, it is necessary to output data after performing 16-bit or 32-bit normalization processing each time the data is output from a processing element via a data network. This necessity may lead to the need for redundant circuits or may cause the lack of bit accuracy. In addition, there is always the need to pay attention to bit accuracy in implementation and debugging phases, thereby possibly impairing development efficiency.

### SUMMARY

According to an aspect of the present invention, the reconfigurable circuit includes:

a multiplier for multiplying a value;

an accumulator for cumulatively adding the multiplied value; and

a round-off processing unit for rounding off the cumulatively added value; wherein the multiplier, the accumulator and the round-off processing unit are disposed within a single processing element and the accumulator provides an output at a timing according to a control signal.

Additional advantages and novel features of aspects of the present invention will be set forth in part in the description that follows, and in part will become more apparent to those skilled in the art upon examination of the following or upon learning by practice thereof.

### BRIEF DESCRIPTION OF THE DRAWINGS

FIG. 1 is a block diagram illustrating a configuration example of a processing element;

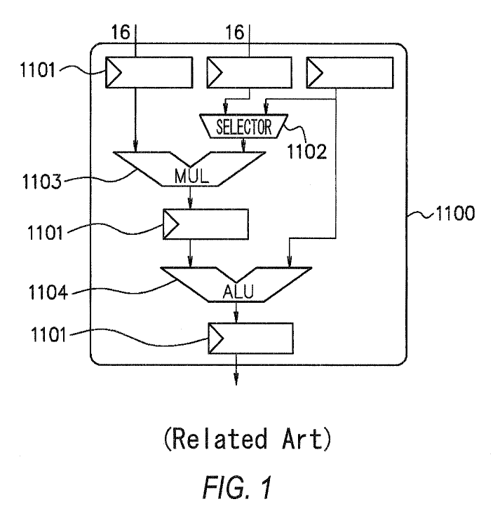

FIG. 2 is a block diagram illustrating a configuration example of a reconfigurable circuit;

FIG. 3 is a block diagram illustrating a configuration example of a processing element in accordance with an embodiment of the present invention;

FIG. 4 is a block diagram illustrating a combinational pattern of arithmetic operations;

FIG. 5 is a block diagram illustrating another combinational pattern of arithmetic operations;

FIG. 6 is a block diagram illustrating yet another combinational pattern of arithmetic operations;

FIG. 7 is a schematic view intended to explain processing performed by shift-and-mask units;

FIG. 8 is a tabular representation illustrating combinational patterns of four types of arithmetic operations according to selection by the selectors shown in FIG. 3;

FIG. 9 is a block diagram illustrating a more specific configuration example of a processing element in accordance with the present embodiment;

FIG. 10 is a flowchart illustrating the error-handling mechanism of a processing element in accordance with the present embodiment;

FIG. 11 is a tabular representation illustrating the control method of an accumulation control unit shown in FIG. 9; and

FIG. 12 is a timing chart illustrating the input and output values of an accumulator.

### DESCRIPTION OF THE PREFERRED EMBODIMENTS

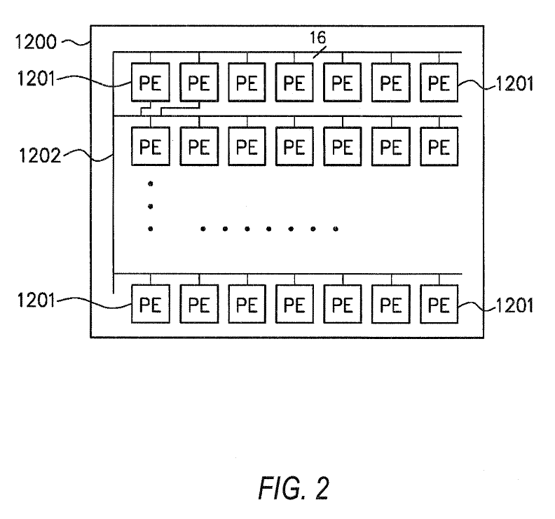

FIG. 2 is a block diagram illustrating a configuration example of a reconfigurable circuit 1200 in accordance with one embodiment of the present invention. The reconfigurable circuit 1200 is an LSI device and includes a plurality of processing elements (PEs) 1201. The inputs and outputs of a plurality of processing elements 1201 can be interconnected with each other via a network 1202. By setting a configuration number, it is possible to change the connection of the network 1202 and perform various types of arithmetic operations. The plurality of processing elements 1201 may have the same in structure as each other or may be different in structure from each other. For example, each processing element may be an ALU, a RAM or a delay circuit.

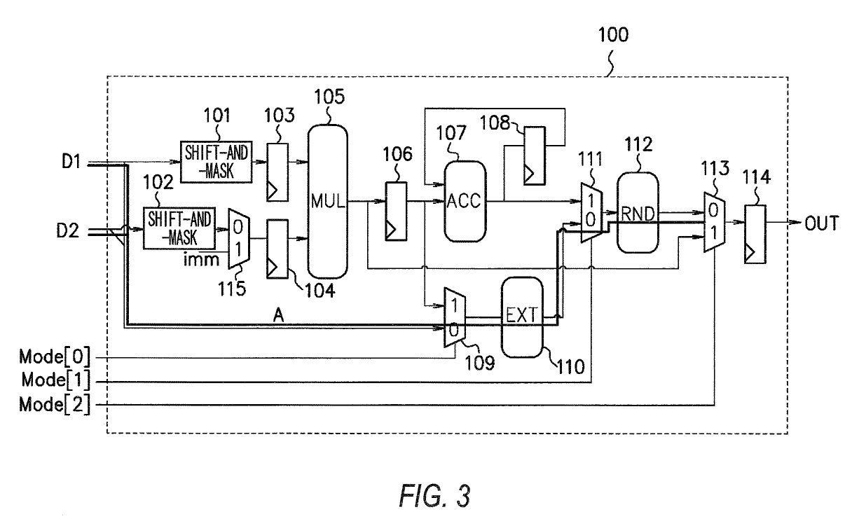

FIG. 3 is a block diagram illustrating a configuration example of one processing element 100. The processing element 100 is one of the plurality of processing elements 1201 shown in FIG. 2 and includes shift-and-mask units 101 and 102, a multiplier (MUL) 105, an accumulator (ACC) 107, a code extender (EXT) 110, a round-off processing unit (RND) 112, selectors 109, 111, 113 and 115, and registers (flip-flops) 103, 104, 106, 108 and 114.

Both external input values D1 and D2 are 16-bit digital values, each having one sign bit and 15 data bits. The shift-and-mask unit 101 bit-shifts and masks the external input value D1, and then outputs the value to the multiplier 105 through the register 103. The shift-and-mask unit 102 bit-shifts and masks the external input value D2, and then outputs the value to the multiplier 105 through the selector 115 and the register 104.

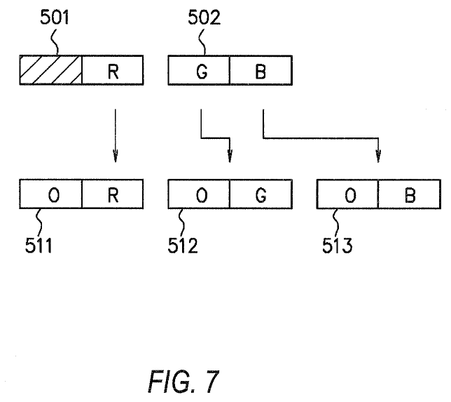

FIG. 7 is a schematic view intended to explain processing performed by the shift-and-mask units 101 and 102. 16-bit image data 501 has lower-order 8 bits of red-color (R) data. 16-bit image data 502 has higher-order 8 bits of green-color (G) data and lower-order 8 bits of blue-color (B) data. The data of one pixel is composed of the red-color data, green-color data and blue-color data. For example, the shift-and-mask unit 101 is provided with an input of the image data 501 as the external input value D1, so that the higher-order 8 bits of the image data 501 are masked and thereby set to “0”, thus leaving over only the lower-order 8 bits of the red-color data and outputting image data 511. Likewise, the shift-and-mask unit 101 is provided with an input of the image data 502 as the external input value D1, so that the 8 bits of the image data 502 are right-shifted and the higher-order 8 bits thereof are masked and thereby set to “0”, thus leaving over only the green-color data and outputting image data 512. Further, the shift-and-mask unit 101 is provided with an input of the image data 502 as the external input value D1, so that the higher-order 8 bits of the image data 502 are masked and thereby set to “0”, thus leaving over only the lower-order 8 bits of the blue-color data and outputting image data 513. With the process described above, it is possible to generate the 16-bit red-color data 511, green-color data 512 and blue-color data 513.

In FIG. 3, the selector 115 selects either one of the output value and the fixed value “imm” of the shift-and-mask unit 102 and outputs the value to the register 104. The register 103 is provided between the shift-and-mask unit 101 and the multiplier 105, and retains and outputs the output value of the shift-and-mask unit 101 to the multiplier 105. The register 104 is disposed between the selector 115 and the multiplier 105, and retains and outputs the output value of the selector 115 to the multiplier 105. The multiplier 105 multiplies the output value of the register 103 by the output value of the register 104 and outputs the multiplied value to the register 106 and the selector 113. The output value of the multiplier 105 is a 32-bit digital value and has two sign bits and 30 data bits. The register 106 is disposed between the multiplier 105 and the accumulator 107, and retains and outputs the output value of the multiplier 105 to the accumulator 107. The register 108 retains the output value of the accumulator 107, and the accumulator 107 adds the output values of the registers 106 and 108. The accumulator 107 and the register 108 constitute a substantial accumulator. That is, the accumulator 107 cumulatively adds the output value of the register 106 and outputs the cumulatively added value to the selector 111.

The selector 109 is provided with an input of a 32-bit value combining the 16-bit external input values D1 and D2. The selector 109 selects one of (a) the 32-bit value combining the external input values D1 and D2 and (b) the output value of the register 106, and outputs the value to the code extender 110 according to a control signal Mode[0]. The code extender 110 performs code extension in order to increase the number of bits of the output value of the selector 109. For example, the input value of the code extender 110 is composed of 32 bits, while the output value thereof is composed of 42 bits. Code extension is a process of increasing the number of bits without changing the value in question. If the value is a positive number, the code extender 110 extends “0” (binary number) to the higher-order bits of the value and if the value is a negative number, the code extender 110 extends “1” (binary number) to the higher-order bits of the value.

The selector 111 is provided with an input of 42-bit values from the accumulator 107 and the code extender 110. Each 42-bit value has one guard bit, one sign bit and 40 data bits. An overflow occurs if a positive value becomes larger than a given maximum value and an underflow occurs if a negative value becomes smaller than a given minimum value. If the 42-bit value is a positive value and is not overflowed, then the guard bit is 0 and the sign bit is 0. If the 42-bit value is a positive value and is overflowed, then the guard bit is 0 and the sign bit is 1. If the 42-bit value is a negative value and is not underflowed, then the guard bit is 1 and the sign bit is 1. If the 42-bit value is a negative value and is underflowed, then the guard bit is 1 and the sign bit is 0. By referring to the guard bit and the sign bit, it is possible to determine whether the value in question is a positive value or a negative value, whether the value is overflowed or not, and whether the value is underflowed or not. The guard bit is generated by the accumulator 107 and the code extender 110.

The selector 111 selects either one of the output values of the accumulator 107 and the code extender 110 and outputs the value to the round-off processing unit 112 according to a control signal Mode[1]. The round-off processing unit 112 performs round-off processing on the output value of the selector 111. Round-off processing is a process of rounding off an input value at a specified digit position. For example, the round-off processing unit 112 rounds off the input value at the first decimal place to the nearest whole number. Note however that if the input value is negative and the first decimal place is 5 (for example, −0.5), the decimal part may be either rounded up or rounded down. For example, the input value of the round-off processing unit 112 is a 42-bit fractional value having an integral part and a decimal part and the output value thereof is a 32-bit integral value consisting only of an integral part. In addition, the round-off processing unit 112 changes the number of output bits (for example, 32 bits or 16 bits) according to a bit mode. Accordingly, it is possible to select either 32 bits or 16 bits for the number of bits of an external output signal and directly use the bits as the input value of another processing element.

The selector 113 selects either one of the output values of the round-off processing unit 112 and the multiplier 105 and outputs the value to the register 114 according to a control signal Mode[2]. The register 114 retains the output value of the round-off processing unit 112 and outputs an external output signal OUT to a network.

As described above, the registers 103 and 104 are disposed between the shift-and-mask units 101 and 102 and the multiplier 105. The register 106 is disposed between the multiplier 105 and the accumulator 107. Accordingly, it is possible to separate pipelines for each function of a shifting-and-masking stage in front of the register 103, a multiplication stage between the registers 103 and 106, and an accumulation (or code extension) and rounding-off stage. Thus, it is possible to execute only required processes. In addition, it is also possible to perform other arithmetic processing on a cycle-by-cycle basis by means of pipeline processing.

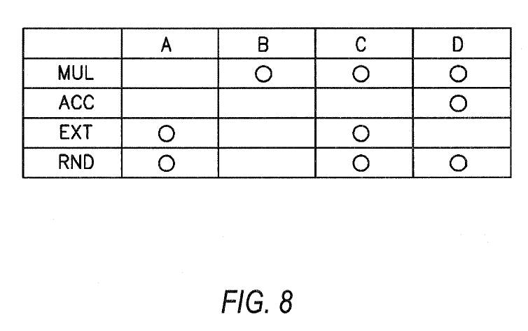

FIG. 8 is a tabular representation illustrating the combinational patterns A to D of four types of arithmetic operations according to selection by the selectors 109, 111 and 113 shown in FIG. 3. The combinational pattern A of arithmetic operations is used to perform the processing of the code extender (EXT) 110 and the round-off processing unit (RND) 112, as shown in FIG. 3. The selector 109 selects the external input values D1 and D2. The code extender 110 performs code extension on the external input values D1 and D2. The selector 111 selects the output value of the code extender 110. The round-off processing unit 112 performs round-off processing on the code-extended external input values D1 and D2. The selector 113 selects the output value of the round-off processing unit 112 and outputs an external output signal OUT.

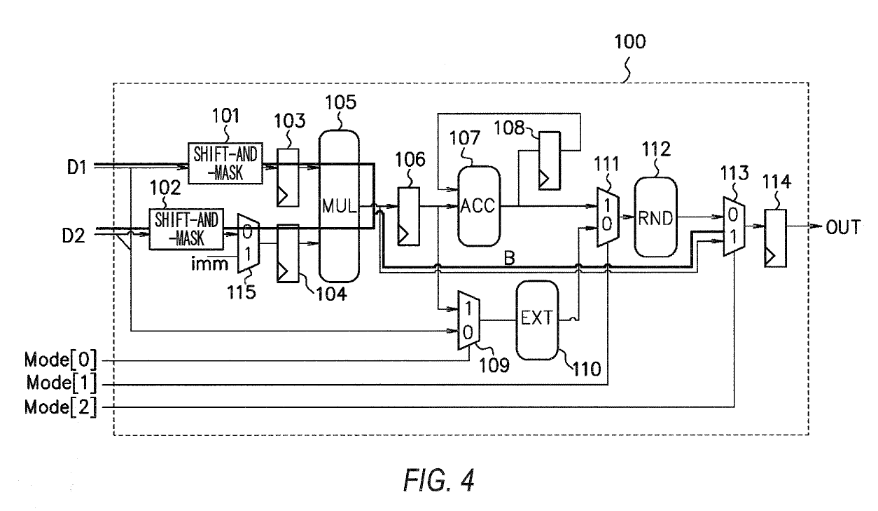

The combinational pattern B is used to perform the processing of the multiplier (MUL) 105, as shown in FIG. 4. The selector 115 selects the external input value D2. The multiplier 105 multiplies the external input value D1 by the external input value D2. The selector 113 selects the output value of the multiplier 105 and outputs the value as an external output signal OUT.

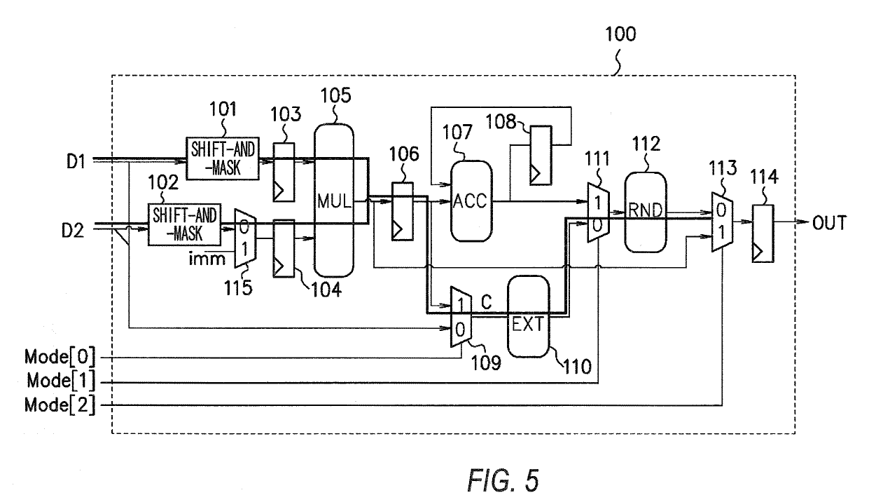

The combinational pattern C is used to perform the processing of the multiplier (MUL) 105, code extender (EXT) 110 and round-off processing unit (RND) 112, as shown in FIG. 5. The selector 115 selects the external input value D2. The multiplier 105 multiplies the external input value D1 by the external input value D2. The selector 109 selects the output value of the register 106. The code extender 110 performs code extension on the multiplied value noted above. The selector 111 selects the output value of the code extender 110. The round-off processing unit 112 performs round-off processing on the code-extended value noted above. The selector 113 selects the output value of the round-off processing unit 112 and outputs the value as an external output value OUT.

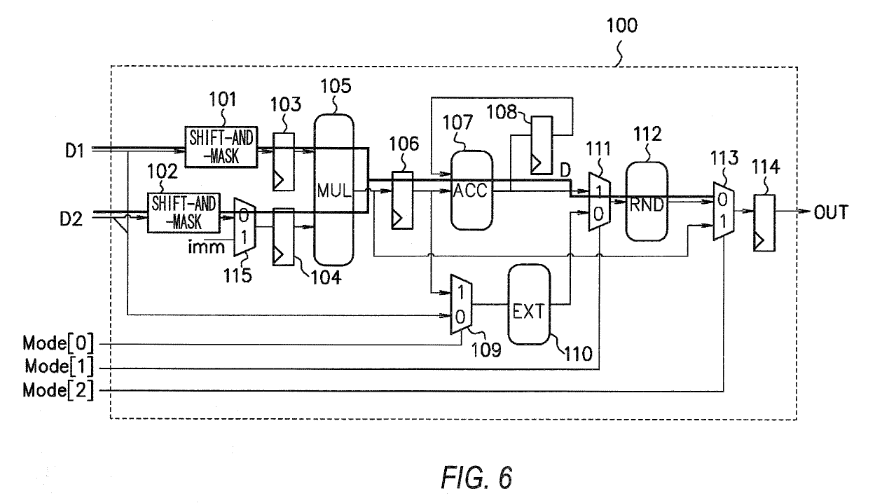

The combinational pattern D is used to perform the processing of the multiplier (MUL) 105, accumulator (ACC) 107 and round-off processing unit (RND) 112, as shown in FIG. 6. The selector 115 selects the external input value D2. The multiplier 105 multiplies the external input value D1 by the external input value D2. The accumulator 107 cumulatively adds the multiplied value noted above. The selector 111 selects the output value of the accumulator 107. The round-off processing unit 112 performs round-off processing on the cumulatively added value noted above. The selector 113 selects the output value of the round-off processing unit 112 and outputs the value as an external output value OUT.

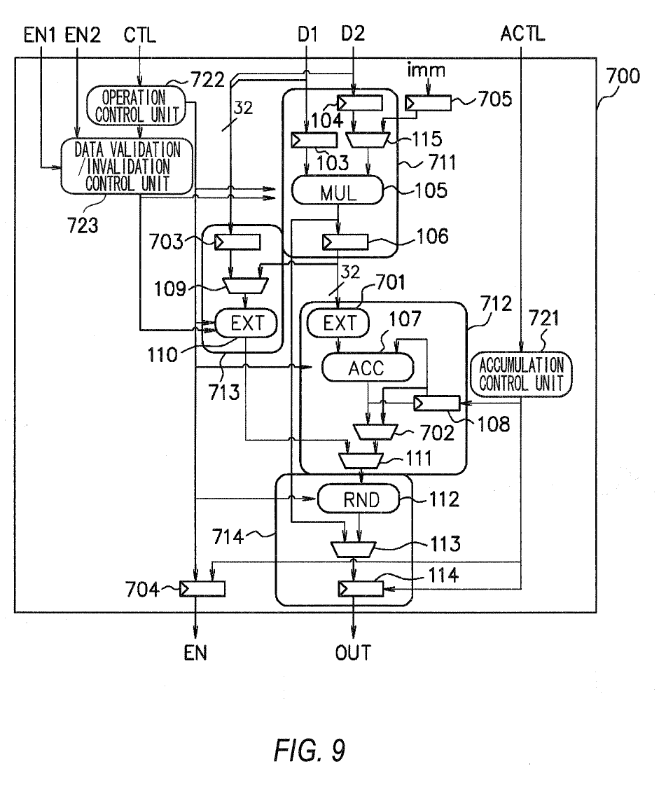

FIG. 9 is a block diagram illustrating a more specific configuration example of a processing element in accordance with the present embodiment. A processing element 700 corresponds to the processing element 100 shown in FIG. 3. Note however that the shift-and-mask units 101 and 102 of FIG. 3 are omitted in the case of the processing element 700. The processing element 700 has a multiplication unit 711, an accumulation unit 712, a code extension unit 713, a round-off processing unit 714, an accumulation control unit 721, an operation control unit 722, and a data validation/invalidation control unit 723.

The register 103 retains the external input value D1. The register 104 retains the external input value D2. A register 705 retains the fixed value “imm”. The selector 115 selects either one of the output values of the registers 104 and 705 and outputs the value to the multiplier 105. The multiplier 105 multiplies the output value of the register 103 by the output value of the selector 115 and outputs the multiplied value. The register 106 retains the output value of the multiplier 105. A code extender 701 performs code extension on the output value of the register 106. The accumulator 107 performs cumulative addition by adding the output values of the code extender 701 and the register 108. The register 108 retains the output value of the accumulator 107. A selector 702 selects one of the output values of the accumulator 107 and the register 108 and outputs the value to the selector 111.

A register 703 retains a 32-bit value combining the external input values D1 and D2. The selector 109 selects one of the output values of the registers 703 and 106 and outputs the value to the code extender 110. The code extender 110 performs code extension on the output value of the selector 109.

The selector 111 selects one of the output values of the code extender 110 and the selector 702 and outputs the value to the round-off processing unit 112. The round-off processing unit 112 performs round-off processing on the output value of the selector 111. The selector 113 selects one of the output values of the round-off processing unit 112 and the multiplier 105 and outputs the value to the register 114. The register 114 retains the output value of the selector 113 and outputs an external output value OUT.

The operation control unit 722 controls the activation/inactivation of the operation of the multiplication unit 711, the accumulation unit 712, the code extension unit 713 and the round-off processing unit 714, according to a control signal CTL, and outputs an enable signal (EN) to a register 704. The register 704 retains the enable signal EN and outputs the signal outside. The enable signal EN is a valid signal showing the validity/invalidity of an external output signal OUT.

The data validation/invalidation control unit 723 controls the activation/inactivation of the operation of the multiplication unit 711 and the code extension unit 713 according to enable signals EN1 and EN2, in order to validate or invalidate the external input values D1 and D2. The enable signal EN1 shows the validity/invalidity of the external input value D1, whereas the enable signal EN2 shows the validity/invalidity of the external input value D2.

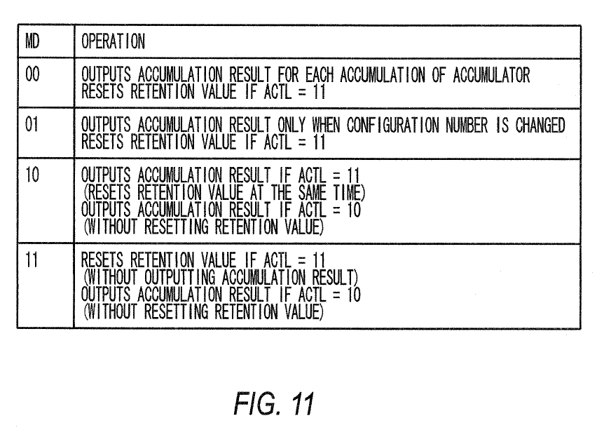

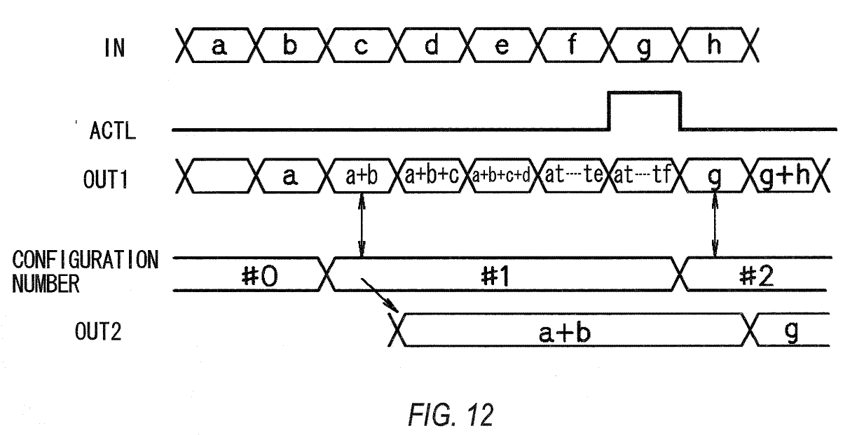

The accumulation control unit 721 controls cumulative addition by controlling the registers 108, 114 and 704 according to a control signal ACTL. The details of this control will be described later with reference to FIGS. 11 and 12.

FIG. 11 is a tabular representation illustrating the control method of the accumulation control unit 721 shown in FIG. 9, and FIG. 12 is a timing chart illustrating the input and output values of the accumulator 107.

First, a description will be made of the operation of the accumulation control unit 721 when an account mode MD is 00 (binary number). The accumulator 107 cumulatively adds an input value IN and outputs an output value OUT1 through the register 108, as shown in FIG. 12. The accumulation control unit 721 controls the register 108, so as to output the result of cumulative addition for each cumulative addition of the accumulator 107. In addition, the accumulation control unit 721 resets the retention value of the register 108 when the control signal ACTL equals 11 (binary number).

Next, a description will be made of the operation of the accumulation control unit 721 when the account mode MD is 01 (binary number). The accumulator 107 cumulatively adds the input value IN and outputs an output value OUT2 through the register 108, as shown in FIG. 12. The accumulation control unit 721 controls the register 108, so as to output the result of cumulative addition only when a configuration number is changed. In addition, the accumulation control unit 721 resets the retention value of the register 108 when the control signal ACTL equals 11 (binary number).

Next, a description will be made of the operation of the accumulation control unit 721 when the account mode MD is 10 (binary number). The accumulation control unit 721 controls the register 108, so as to output the result of cumulative addition when the control signal ACTL equals 11 (binary number) and, at the same time, reset the retention value of the register 108. In addition, the accumulation control unit 721 controls the register 108, so as to output the result of cumulative addition when the control signal ACTL equals 10 (binary number) and not to reset the retention value of the register 108 at that time.

Next, a description will be made of the operation of the accumulation control unit 721 when the account mode MD is 11 (binary number). The accumulation control unit 721 controls the register 108, so as not to output the result of cumulative addition but to reset the retention value of the register 108 when the control signal ACTL equals 11 (binary number). In addition, the accumulation control unit 721 controls the register 108, so as to output the result of cumulative addition when the control signal ACTL equals 10 (binary number) and not to reset the retention value of the register 108 at that time.

As described above, the accumulator including the register 108 and the accumulator 107 outputs the result of cumulative addition at a timing according to the control signal ACTL and rests the retention value according to the control signal ACTL. By performing control using the accumulation control signal ACTL, it is possible to control cumulative addition and the output timing thereof, while continuously carrying out data processing.

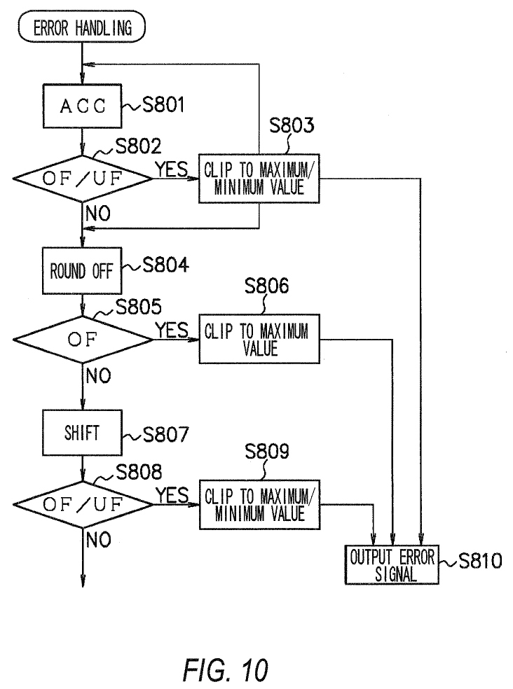

FIG. 10 is a flowchart illustrating the error-handling mechanism of a processing element in accordance with the present embodiment. In step S801, the accumulator 107 performs cumulative addition. Next, in step S802, the accumulator 107 checks whether the cumulatively added value noted above is overflowed that means includes more than a maximum number of bits or underflowed that means includes less than a minimum number of bits. If the value is overflowed or underflowed, then the processing element goes to step S803. If the value is neither overflowed nor underflowed, then the processing element goes to step S804.

In step S803, the accumulator 107 maximizes (clips) the above-noted cumulatively added value if the value is overflowed, or minimizes (clips) the cumulatively added value if the value is underflowed. Then, the processing element goes to step S801, step S804 or step S810. In step S810, the accumulator 107 outputs an error signal. In step S801, the accumulator 107 proceeds to the next cumulative addition.

In step S804, the round-off processing unit 112 performs round-off processing. The round-off processing discussed here includes round-off processing with respect to cumulatively added values and external input values. Note that the round-off processing unit 112, when provided with an input of the above-noted error signal from the accumulator 107, bypasses the round-off processing of the cumulatively added value in question.

Next, in step S805, the round-off processing unit 112 checks whether the rounded-off value noted above is overflowed or not. An overflow may occur at the time of carry addition in round-off processing. The processing element goes to step S806 if the value is overflowed, or goes to step S807 if the value is not overflowed.

In step S806, the processing element maximizes (clips) the above-noted rounded-off value if the value is overflowed, and goes to step S810. In step S810, the round-off processing unit 112 outputs an error signal.

In step S807, the round-off processing unit 112 bit-shifts the rounded-off value if the integer bit count of an input value differs from the integer bit count of an output value. If the integer bit count of the input value is greater than the integer bit count of the output value, the rounded-off value may overflow due to the bit-shifting noted above.

Next, in step S808, the round-off processing unit 112 checks whether the bit-shifted value noted above is overflowed or underflowed. The processing element goes to step S809 if the value is overflowed or underflowed, or terminates processing if the value is neither overflowed nor underflowed.

In step S809, the round-off processing unit 112 maximizes (clips) the above-noted bit-shifted value if the value is overflowed due to the bit-shifting, or minimizes (clips) the bit-shifted value if the value is underflowed. Then, the round-off processing unit 112 goes to step S810. In step S810, the round-off processing unit 112 outputs an error signal. By determining the amount of the bit-shifting, it is possible to change the amount of rounding off, clip processing based on valid bits, and the maximum and minimum values.

The accumulator 107 outputs the error signal to the round-off processing unit 112. Accordingly, it is possible for the round-off processing unit 112 to collectively output an error signal due to cumulative addition and an error signal due to round-off processing. The round-off processing unit 112 can bypass round-off processing when an error signal due to cumulative addition is output. According to the present embodiment, it is possible to reduce the circuit scale and the number of actions taken by a computing unit by allowing the accumulator 107 and the round-off processing unit 112 to separately have error output units.

As heretofore described, according to the present embodiment, the multiplier 105, the accumulator 107, and the round-off processing unit 112 are disposed within a single unit of the processing element 100. Since multiplication, cumulative addition and round-off processing can be performed within the single unit of the processing element 100, there is no need for control among a plurality of processing elements when performing these arithmetic operations. Thus, it is possible to improve bit accuracy among these arithmetic operations.

In the present embodiment, the frequently-used functions of the multiplier 105 and accumulator 107 are collectively built into a single unit of the processing element 100. Accordingly, it is possible to avoid wasting data networks external to processing elements and to eliminate the need for timing adjustment among a plurality of processing elements. In addition, it is possible to make a sign bit and a guard bit to be carried by the output of the multiplier 105 or by the output of the accumulator 107 since the multiplier 105 and the accumulator 107 are closed within a processing element. Thus, it is possible to increase computational accuracy.

Furthermore, since the accumulator 107 and the round-off processing unit 112 are implemented within the same processing element 100, it is possible to perform round-off processing at the round-off processing unit 112 without impairing the bit accuracy of values cumulatively added by the accumulator 107.

Still further, it is possible to prescribe the bit accuracy of the external input value D1 and D2 and the external output value OUT, share setup information and reduce the number of registers (circuit scale), by specifying valid bit accuracy.

Example embodiments of aspects of the present invention have now been described in accordance with the above advantages. It will be appreciated that these examples are merely illustrative of aspects of the present invention. Many variations and modifications will be apparent to those skilled in the art.

What is claimed is:

1. A reconfigurable circuit comprising:
a multiplier for multiplying a value;
an accumulator for cumulatively adding said multiplied value; and
a round-off processing unit for rounding off said cumulatively added value;
wherein said multiplier, said accumulator and said round-off processing unit are disposed within a single processing element, and said accumulator provides an output in accordance with a timing control signal.

2. The reconfigurable circuit according to claim 1, wherein said accumulator performs reset operation according to a control signal.

3. The reconfigurable circuit according to claim 1, further including:
a code extender disposed within said single processing element to perform code extension in order to increase the number of bits of said multiplied value; and
a first selector for selecting the output value of one of said accumulator and said code extender and outputting said output value to said round-off processing unit.

4. The reconfigurable circuit according to claim 1, further including shift-and-mask units disposed within said single processing element to bit-shift and mask two digital values and output said bit-shifted and masked values to said multiplier.

5. The reconfigurable circuit according to claim 1, wherein said accumulator maximizes a cumulatively added value if said cumulatively added value is overflowed, minimizes said cumulatively added value if said cumulatively added value is underflowed, and outputs an error signal.

6. The reconfigurable circuit according to claim 5, wherein said round-off processing unit bypasses the round-off processing of said cumulatively added value if said error signal is output.

7. The reconfigurable circuit according to claim 1, wherein said round-off processing unit maximizes a rounded-off value if said rounded-off value is overflowed, and outputs an error signal.

8. The reconfigurable circuit according to claim 1, wherein said round-off processing unit bit-shifts said rounded-off value if the integer bit count of an input value differs from the integer bit count of an output value.

9. The reconfigurable circuit according to claim 8, wherein said round-off processing unit maximizes said bit-shifted value if said bit-shifted value is overflowed due to said bit-shifting, minimizes said bit-shifted value if said bit-shifted value is underflowed due to said bit-shifting, and outputs an error signal.

10. The reconfigurable circuit according to claim 1, wherein said round-off processing unit changes the number of output bits according to a bit mode.

11. The reconfigurable circuit according to claim 1, further including a first selector disposed within said single processing element to select and output the output value of one of said multiplier and said round-off processing unit.

12. The reconfigurable circuit according to claim 3, further including a second selector disposed within said single processing element to select one of the output value of said multiplier and an external input value and output said output value or said input value to said code extender.

13. The reconfigurable circuit according to claim 1, further including registers disposed within said single processing element between said multiplier and said accumulator.

14. The reconfigurable circuit according to claim 4, further including:
a first register disposed within said single processing element between said shift-and-mask unit and said multiplier; and
a second register disposed within said single processing element between said multiplier and said accumulator.

15. The reconfigurable circuit according to claim 11, further including:
a code extender disposed within said single processing element to perform code extension in order to increase the number of bits of said multiplied value; and
a second selector for selecting the output value of one of said accumulator and said code extender and output said output value to said round-off processing unit.

16. The reconfigurable circuit according to claim 15, further including a third selector disposed within said single processing element to select one of the output value of said multiplier and an external input value and output said output value or said input value to said code extender.

17. The reconfigurable circuit according to claim 16, further including shift-and-mask units disposed within said single processing element to bit-shift and mask two digital values and output said bit-shifted and masked values to said multiplier.

18. The reconfigurable circuit according to claim 17, further including:
a first register disposed within said single processing element between said shift-and-mask unit and said multiplier; and
a second register disposed within said single processing element between said multiplier and said accumulator.
